(19) United States
(12) Patent Application Publication
(10) Pub. No.: US 2021/0281561 A1
(43) Pub. Date: Sep. 9, 2021

(54) CERTIFICATION FOR CONNECTION OF VIRTUAL COMMUNICATION ENDPOINTS

(71) Applicant: International Business Machines Corporation, Armonk, NY (US)

(72) Inventors: Ramanjaneya Sarma Burugula, Yorktown Heights, NY (US); Niteesh Kumar Dubey, Yorktown Heights, NY (US); Joefon Jann, Ossining, NY (US); Ching-Farn Eric Wu, Yorktown Heights, NY (US); Hao Yu, Valhalla, NY (US)

(21) Appl. No.: 16/813,178

(22) Filed: Mar. 9, 2020

(51) Int. Cl. H04L 29/06; G06F 9/455

(52) U.S. Cl. CPC H04L 63/0823; G06F 2009/45587; G06F 9/45558; H04L 63/0435

(57) ABSTRACT

Provided is a method for certifying a communicative connection. The method includes, in response to receiving a first request from a first virtualized communication endpoint (VCE), allocating and assigning a first communication portal to the first VCE, generating an encryption key associated with the first communication portal, and returning the encryption key and an identification of the first communication portal to the first VCE. The method further includes, in response to receiving a second request from a second VCE to establish a communicative connection with the first communication portal, the second request being accompanied by an encrypted certificate, comparing, using the encryption key, the information included in the certificate with certificate input information. The method further includes, in response to determining that the information included in the certificate matches the certificate input information, establishing the communicative connection between the first VCE and the second VCE.

### BACKGROUND

The present disclosure relates generally to virtualized computing systems, and more particularly to certifying a communicative connection between virtual communication endpoints in a virtualized server environment.

A computer or server maintains a number of computing resources. A hypervisor, which runs on the computer or server, can typically be used to create and run a number of virtual machines and to manage the access of those virtual machines to the computing resources. The virtual machines can also be referred to as virtual communication endpoints. The virtual environment created by the hypervisor can also be referred to as a virtualized server environment.

### SUMMARY

Embodiments of the present disclosure include a method, computer program product, and system for certifying a communicative connection between two communication endpoints in a virtualized server environment. The method comprises, in response to receiving a first request from a first virtualized communication endpoint (VCE), allocating and assigning a first communication portal to the first VCE, generating an encryption key associated with the first communication portal, and returning the encryption key and an identification of the first communication portal to the first VCE. The method further comprises, in response to receiving a second request from a second VCE to establish a communicative connection with the first communication portal, the second request being accompanied by an encrypted certificate, comparing, using the encryption key, the information included in the certificate with certificate input information. The method further comprises, in response to determining that the information included in the certificate matches the certificate input information, establishing the communicative connection between the first VCE and the second VCE.

The above summary is not intended to describe each illustrated embodiment or every implementation of the present disclosure.

### BRIEF DESCRIPTION OF THE DRAWINGS

The drawings included in the present disclosure are incorporated into, and form part of, the specification. They illustrate embodiments of the present disclosure and, along with the description, serve to explain the principles of the disclosure. The drawings are only illustrative of typical embodiments and do not limit the disclosure.

FIG. 1 illustrates a block diagram of an example virtualized computing environment, in accordance with embodiments of the present disclosure.

FIG. 2 depicts a schematic drawing of interactions between components of the example virtualized computing environment of FIG. 1, in accordance with embodiments of the present disclosure.

FIG. 3 illustrates a flowchart of an example method for certifying a communicative connection between two virtual components of the example virtualized computing environment, in accordance with embodiments of the present disclosure.

FIG. 4 illustrates a high-level block diagram of an example computer system that may be used in implementing one or more of the methods, tools, and modules, and any related functions, described herein, in accordance with embodiments of the present disclosure.

FIG. 5 depicts a cloud computing environment, in accordance with embodiments of the present disclosure.

FIG. 6 depicts abstraction model layers, in accordance with embodiments of the present disclosure.

While the embodiments described herein are amenable to various modifications and alternative forms, specifics thereof have been shown by way of example in the drawings and will be described in detail. It should be understood, however, that the particular embodiments described are not to be taken in a limiting sense. On the contrary, the intention is to cover all modifications, equivalents, and alternatives falling within the spirit and scope of the disclosure.

### DETAILED DESCRIPTION

Aspects of the present disclosure relate generally to the field of virtualized computing systems, and more particularly to certifying a communicative connection between virtual communication endpoints in a virtualized server environment. While the present disclosure is not necessarily limited to such applications, various aspects of the disclosure may be appreciated through a discussion of various examples using this context.

In a computing environment, a trusted resource manager can be used to manage computing resources of a physical server and allocate those computing resources to a plurality of different virtual communication endpoints (VCEs) while maintaining isolation of those VCEs from one another. In the present disclosure, the trusted resource manager is preferably a hypervisor. However, in some alternative embodiments, the trusted resource manager may also be a different entity, such as a container engine. Accordingly, a VCE may be associated with, for example: a virtual machine, a container, or a software process. Commonly, the computing resources of a physical server are utilized by VCEs that belong to different business entities. It is generally assumed that each business entity does not know or trust the others, and therefore does not want its information or operating systems exposed to the information or operating systems of other business entities. The hypervisor provides the virtualization features to the VCEs and ensures that the physical resources allocated to one VCE are not visible to other VCEs.

Typically, to minimize interruptions to software running in VCEs, the hypervisor provides services to the VCEs passively. In other words, the hypervisor only performs a task when it receives a request from a VCE. One downside of this passive invocation style is that the ability of the hypervisor to communicate with a VCE is limited. For example, if it is desirable for the hypervisor to send a one-way notification to a VCE, the hypervisor cannot spontaneously or independently initiate this communication with the VCE.

Sometimes, it is desirable for a pair of VCEs in a system to share a critical resource that is managed by the hypervisor. Such a resource can be, for example, a communication channel or a memory buffer. Sharing the resource typically requires the hypervisor's enablement, which typically requires the hypervisor to receive permission from each participating VCE. However, as explained above, because the hypervisor operates with a passive invocation style, enablement by the hypervisor cannot be initiated by the hypervisor. Instead, only the VCEs can initiate the enablement of such resource sharing.

Disclosed is a method and apparatus to facilitate resource sharing between two VCEs. For example, in some embodiments of the present disclosure, the method can be used to facilitate establishment of a trusted connection between a pair of dynamically connected communication portals that are owned, respectively, by a pair of VCEs, wherein it is assumed that the functionalities hosted in the VCEs are untrusted by one another.

In one particular example embodiment discussed herein, it is desirable for a first VCE to be able to efficiently deposit a message or notification to a second VCE through a dynamically connected communication channel. The first VCE and the second VCE are managed by the same hypervisor and share resources hosted by the same server. Accordingly, the method includes a request from the first VCE to the hypervisor to establish the dynamically connected communication channel by connecting a dynamically configurable communication portal owned by the first VCE with a dynamically configurable communication portal that is owned by the second VCE. As discussed in further detail below, because the first VCE should not be allowed to deposit a message or notification to the second VCE without permission from the second VCE, the hypervisor will only establish the dynamically connected communication channel between the portals owned by the first and second VCEs if the request from the first VCE is accompanied by a certificate generated by the second VCE.

More specifically, in the example embodiment discussed herein, the second VCE generates the certificate in response to receiving a request from the first VCE. Thus, the certificate is specific to the request from the first VCE. Accordingly, the certificate includes the identification of the first VCE. The certificate is returned to the first VCE, and the first VCE can then submit the certificate, along with the request to establish the dynamically connected communication channel, to the hypervisor for verification. Once the certificate has been successfully verified by the hypervisor, the hypervisor then establishes the dynamically connected communication channel. Once the communication channel has been established, the first VCE can directly deposit a message or notification to the second VCE.

As discussed in further detail below, the efficacy and efficiency of this digital certification process is improved by applying symmetric encryption. Symmetric encryption allows copies of a single key to be used both by the second VCE and the hypervisor. The second VCE uses the key to encrypt information in the certificate that it sends to the first VCE, and the hypervisor uses a copy of the same key to decrypt information in the certificate that it receives from the first VCE. Accordingly, applying symmetric encryption to the digital certification process overcomes problems associated with the passive invocation style of the hypervisor without compromising the integrity of the separation of VCEs managed by the same hypervisor.

It is to be understood that the aforementioned advantages are example advantages and should not be construed as limiting. Embodiments of the present disclosure can contain all, some, or none of the aforementioned advantages while remaining within the spirit and scope of the present disclosure.

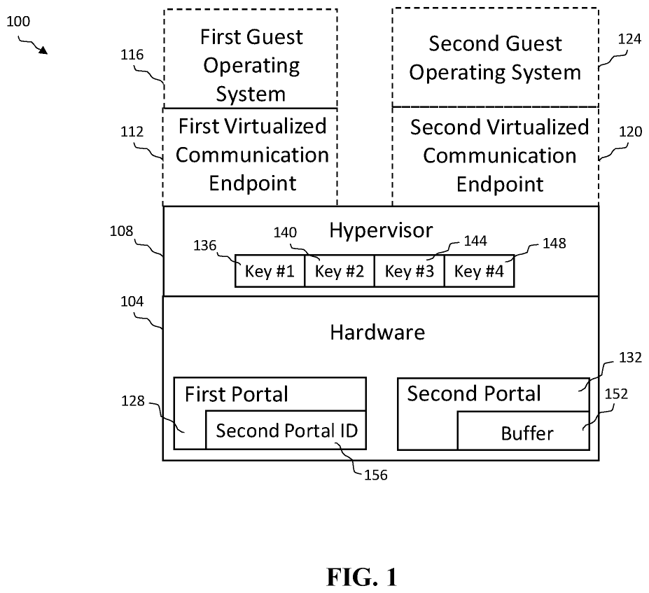

Turning now to the figures, FIG. 1 depicts an example computing environment 100 in which an embodiment of the present disclosure can be applied. The computing environment 100 includes hardware 104, a hypervisor 108 configured to manage the computing resources of the hardware 104, a first VCE 112 running on the hypervisor 108, a first guest operating system 116 running on the first VCE 112, a second VCE 120 running on the hypervisor 108, and a second guest operating system 124 running on the second VCE 120. In some embodiments of the present disclosure, the first VCE 112 is a first virtual machine (VM) and the second VCE 120 is a second VM. In some embodiments of the present disclosure, the first VM and the second VM are distinct from one another. As discussed in further detail below, some of the computing resources held by the hardware 104 and managed by the hypervisor 108 include portal 128 and portal 132. Some of the information managed and stored by the hypervisor 108 includes encryption keys 136, 140, 144, 148. Encryption keys are associated with portals, such as portal 128 and portal 132.

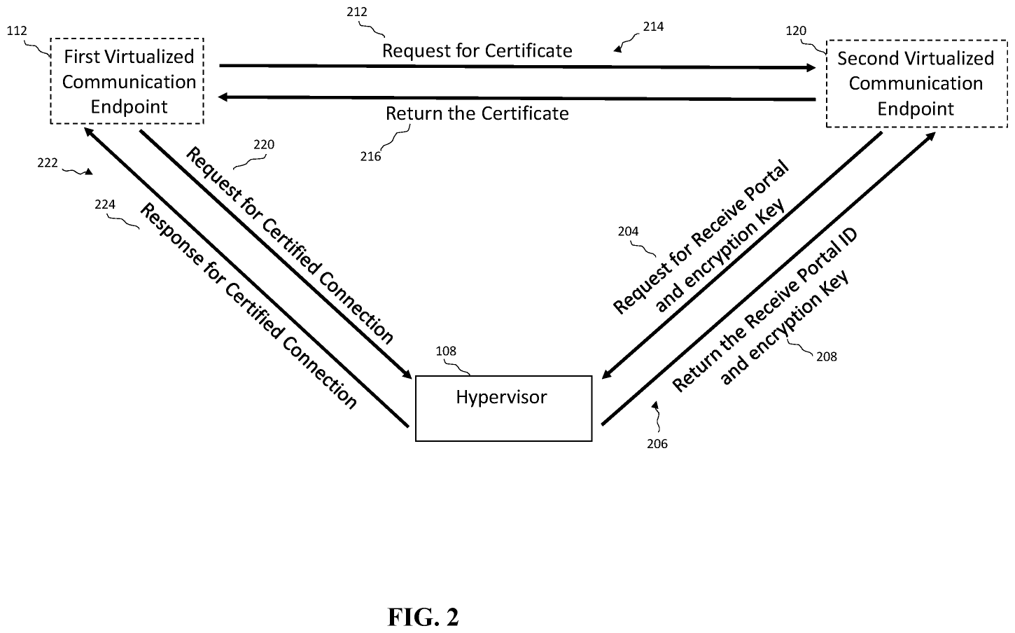

As shown in FIG. 2, the hypervisor 108, the first VCE 112, and the second VCE 120 are configured to interact with one another by sending requests 204, 212, 220 and responses 208, 216, 224 to one another. Requests from the first or second VCE 112, 120 to the hypervisor 108 can also be referred to as “hypervisor calls.” Corresponding responses associated with respective hypervisor calls can also be referred to as “returns.” As discussed in further detail below, such a request (or “call”) and response (or “return”) pair can be performed independently of any other task.

In particular, as discussed in further detail below, the second VCE 120 is configured to send a request 204 to the hypervisor 108, and the hypervisor 108 is configured to return a response 208 to the request 204 back to the second VCE 120. This request 204 and response 208 can be considered a first pair of communications 206. Additionally, the first VCE 112 is configured to send a request 212 to the second VCE 120, and the second VCE 120 is configured to return a response 216 back to the first VCE 112. This request 212 and response 216 can be considered a second pair of communications 214. Additionally, the first VCE 120 is configured to send a request 220 to the hypervisor 108, and the hypervisor 108 is configured to return a response 224 back to the first VCE 112. This request 220 and response 224 can be considered a third pair of communications 222.

These three pairs of communications 206, 214, 222 must occur in the following order: first pair 206, second pair 214, third pair 222. However, each pair of communications may be temporally independent from the other pairs. In other words, the occurrence of the first pair of communications 206 does not trigger or cause the occurrence of the second pair of communications 214. For example, in some embodiments of the present disclosure, the first pair of communications 206 can be performed as a set-up task, in anticipation that a need for the response 208 provided by the hypervisor 108 will later arise. Likewise, the occurrence of the second pair of communications 214 does not trigger or cause the occurrence of the third pair of communications 222. The duration of time between the occurrence of each pair of communications is not relevant to the disclosure.

Additionally, although not shown in FIG. 2, another pair of communications is enabled by the computing environment 100. This “additional pair” of communications occurs between the first VCE 112 and the hypervisor 108 and includes a request from the first VCE 112 to the hypervisor 108 and a response returned from the hypervisor 108 back to the first VCE 112. Like the other pairs of communications, the additional pair of communications may be temporally independent from the other pairs. In some embodiments of the present disclosure, the additional pair of communications may be considered part of the set-up of the computing environment 100 and therefore not an explicit, independent pair of communications. In some embodiments of the present disclosure, the additional pair of communications may occur prior to the occurrence of the first pair of communications 206 described above. In alternative embodiments of the present disclosure, the additional pair of communications may occur prior to the occurrence of the second pair of communications 214 described above.

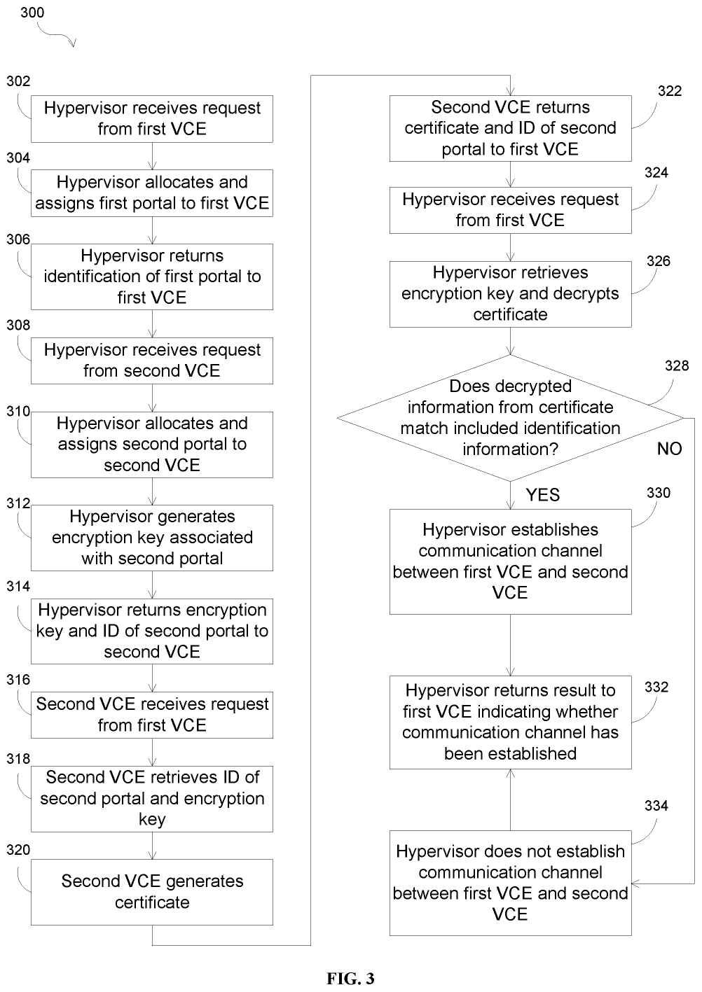

Referring now to FIG. 3, an example embodiment of the method 300 of establishing a dynamically connected communication channel between the first VCE 112 and the second VCE 120 is depicted. The method 300 includes the occurrence of the pairs of communications 206, 214, 222, and the additional pair of communications, discussed above. In some alternative embodiments of the present disclosure, the method 300 does not explicitly include the occurrence of the additional pair of communications.

In method 300, the first VCE 112 initiates the procedure of establishing a dynamically connected communication channel to deposit a message or notification to the second VCE 120. Accordingly, the first VCE 112 may also be referred to as a “send VCE” and the second VCE 120 may also be referred to as a “receive VCE.” Furthermore, operations and features associated with the send VCE may also be indicated by application of the term “send” and operations and features associated with the receive VCE may also be indicated by application of the term “receive.”

More specifically, the method 300 begins with operation 302, wherein the first VCE 112 sends a request to the hypervisor 108 asking the hypervisor 108 to allocate and assign a communication portal to the first VCE 112. In other words, at operation 302, the hypervisor 108 receives a request from the first VCE 112. The input parameters of the request include the identification of the first VCE 112 in the virtualized server environment.

At operation 304, in response to the request, the hypervisor 108 allocates a communication portal and assigns it to the first VCE 112. The hypervisor 108 associates the assigned communication portal with the first VCE 112 and stores the identification of the assigned communication portal together with the identification of the first VCE 112 in the data 128 associated with the first VCE 112. Accordingly, the assigned communication portal can then be referred to as the “first portal.” The data 128 associated with the first VCE 112 includes configuration data 156 pertaining to the first portal.

At operation 306, the hypervisor 108 returns the identification of the first portal to the first VCE 112. The operations 302, 304, and 306 include the additional pair of communications between the first VCE 112 and the hypervisor 108.

At operation 308, the second VCE 120 sends a request to the hypervisor 108 to allocate and assign a communication portal. In other words, at operation 308, the hypervisor 108 receives a request from the second VCE 120. This request corresponds to request 204 shown in FIG. 2. The input parameters of the request include the identification of the second VCE 120 in the virtualized server environment and the address of a memory region, which is referred to as a buffer space.

At operation 310, in response to receiving the request from the second VCE 120, the hypervisor 108 allocates an available portal and assigns it to the requesting second VCE 120. The hypervisor 108 associates the assigned communication portal with the second VCE 120 and stores the identification of the assigned communication portal together with the identification of the second VCE 120 in the data 132 that is associated with the second VCE 120. Accordingly, the assigned communication portal can then be referred to as the “second portal.” The hypervisor 108 then stores the address of the buffer space in the configuration data 152 pertaining to the second portal. This configuration data 152 pertaining to the second portal is included in the data 132 that is associated with the second VCE 120 (which includes the identification of the second portal).

At operation 312, once the hypervisor 108 has allocated and assigned the second portal and stored the address of the buffer space, the hypervisor 108 generates a symmetric encryption key (see 136 in FIG. 1). The newly generated key 136 is stored in the hypervisor 108. An association of the newly generated key 136 and the identification of the second VCE 120 are also stored in the hypervisor 108.

At operation 314, the hypervisor 108 returns a copy of the key 136 and the identification of the second portal to the requesting second VCE 120. This return corresponds to the response 208 shown in FIG. 2. Once the second VCE 120 has received the copy of the key 136 and the identification of the second portal from the hypervisor 108, the second VCE 120 associates the identification of the second portal with the copy of the key 136 and stores them locally. The operations 308, 310, 312, and 314 include the first pair of communications 206 between the second VCE 120 and the hypervisor 108.

As mentioned above, the first pair if communications 206 occurs independently of other operations. In the embodiment of the method 300 shown in FIG. 3, operation 308 occurs independently of operations 302, 304, and 306, and after operation 306. However, in some alternative embodiments of the present disclosure, operations 308, 310, 312, and 314 (which include the first pair of communications 206) can occur prior to operations 302, 304, and 306 (which include the additional pair of communications).

Operation 316 occurs independently of operations 302-314. At operation 316, the first VCE 112 sends a request to the second VCE 120 for a certificate. In other words, at operation 316, the second VCE 120 receives a request from the first VCE 112. For example, the first VCE 112 may send such a request in the event that it is desirable for the first VCE 112 to establish a communicative connection with the second VCE 120 to deposit a message or notification to the second VCE 120. This request corresponds to the request 212 shown in FIG. 2. The request for a certificate includes the identification of the first VCE 112 and the identification of the first portal, which is available for establishing the communicative connection.

At operation 318, upon receiving this request from the first VCE 112, the second VCE 120 retrieves the identification of the second portal and the corresponding associated key 136. At operation 320, the second VCE 120 then generates a certificate by performing an encryption procedure using the key 136. The input into the encryption procedure may include, but is not limited to, the identification of the first VCE 120, the identification of the first portal, and the identification of the second portal.

It is noted that, in order to perform operation 320, the second VCE 120 must have the key 136 as well as each piece of information that is required as an input into the encryption procedure. These pieces of information may also be referred to herein collectively as “certificate input information.” Accordingly, while it has been noted that operations 302-316 may occur independently from one another and do not necessarily need to occur in the order presented in the embodiment illustrated by the method 300, in order for operation 320 to be possible, each of operations 302-318 must have occurred prior to operation 320. In other words, it is possible for at least some of the operations 302-314 to be performed after operation 316 and/or after operation 318. For example, in one alternative embodiment of the present disclosure, the first VCE 112 may perform operation 316, sending a request to the second VCE 120 for a certificate, and operations 308-314 may occur after the second VCE 120 has received the request for the certificate. More specifically, the second VCE 120 can perform operation 318, retrieving the identification of the second portal and the key, any time after operation 314, when the second VCE 120 receive the encryption key and the identification of the second portal. Accordingly, in this alternative embodiment, operations 308-314 occur between operations 316 and 318.

At operation 322, once the second VCE 120 has generated the certificate, the second VCE 120 responds to the request for a certificate from the first VCE 112 by returning the certificate together with the identification of the second portal. This return corresponds to the response 216 shown in FIG. 2. The operations 316, 318, 320, and 322 include the second pair of communications 214 between the first VCE 112 and the second VCE 120.

In response to receiving the certificate and the identification of the second portal from the second VCE 120, the first VCE 112 associates the certificate with the identification of the second portal and stores them locally. Once the first VCE 112 has the certificate and the identification of the second portal, the first VCE 112 can request the hypervisor 108 to establish a communicative channel directly between the first VCE 112 and the second VCE 120 via the first portal and the second portal. In other words, the first VCE 112 can request permission from the hypervisor 108 to send communications directly to the second portal of the second VCE 120.

Operation 324 occurs independently of operations 302-322, but after operation 322. At operation 324, to request this permission, the first VCE 112 sends a request for certified connection to the hypervisor 108. In other words, at operation 324, the hypervisor 108 receives a request from the first VCE 112. This request corresponds to request 220 shown in FIG. 2. The input parameters of the request for certified connection include the identification of the first VCE 112, the identification of the first portal, the identification of the second portal, and the certificate that the first VCE 112 received from the second VCE 120. In other words, the request must include the certificate as well as each piece of the certificate input information.

At operation 326, in response to receiving the request from the first VCE 112, the hypervisor 108 looks up the key 136 that is associated with the identification of the second portal. Once the key 136 has been retrieved, the hypervisor 108 uses that key 136 to perform a decryption procedure, using the certificate as the input. The output of the decryption procedure includes: (i) the identification of the first VCE 112; (ii) the identification of the first portal; and (iii) the identification of the second portal. In other words, the output of the decryption procedure includes the certificate input information that was encrypted by the second VCE 120 when the second VCE 120 generated the certificate.

At operation 332, the hypervisor 108 compares the outputted identification of the first VCE 112 with the identification of the first VCE 112 that was included with the certified connection request. Similarly, the hypervisor 108 compares the outputted identification of the first portal with the identification of the first portal that was included with the certified connection request. Furthermore, the hypervisor 108 compares the outputted identification of the second portal with the identification of the second portal that was included with the certified connection request. By comparing these identifications, it is possible for the hypervisor 108 to verify whether the first VCE 112 has properly received permission (in the form of the certificate) from the second VCE 120 prior to requesting that the hypervisor 108 establish a communicative channel directly between the first VCE 112 and the second VCE 120.

At operation 330, if the hypervisor 108 determines that the outputted identifications are identical to the identifications that were included with the certified connection request, the hypervisor establishes the direct communication channel between the first VCE 112 and the second VCE 120. For example, in some embodiments of the present disclosure, the hypervisor 108 records the identification of the second portal into the configuration data 156 (shown in FIG. 1) of the first portal. In particular, in some embodiments of the present disclosure, the hypervisor 108 records the identification of the second portal into a “second portal ID” field in the configuration data 156 of the first portal.

At operation 332, the hypervisor 108 then responds to the certified connection request from the first VCE 112 by indicating that the certified communication channel has been established. This response corresponds to response 224 shown in FIG. 2.

Alternatively, at operation 334, if the hypervisor 108 determines that the outputted identifications are not identical to the identifications that were included with the certified connection request, the hypervisor 108 does not perform any further actions other than responding to the certified connection request by indicating that the certified communication channel has not been established at operation 332. This alternative response also corresponds to response 224 shown in FIG. 2. The operations 324-334 include the third pair of communications 222 between the first VCE 112 and the hypervisor 108.

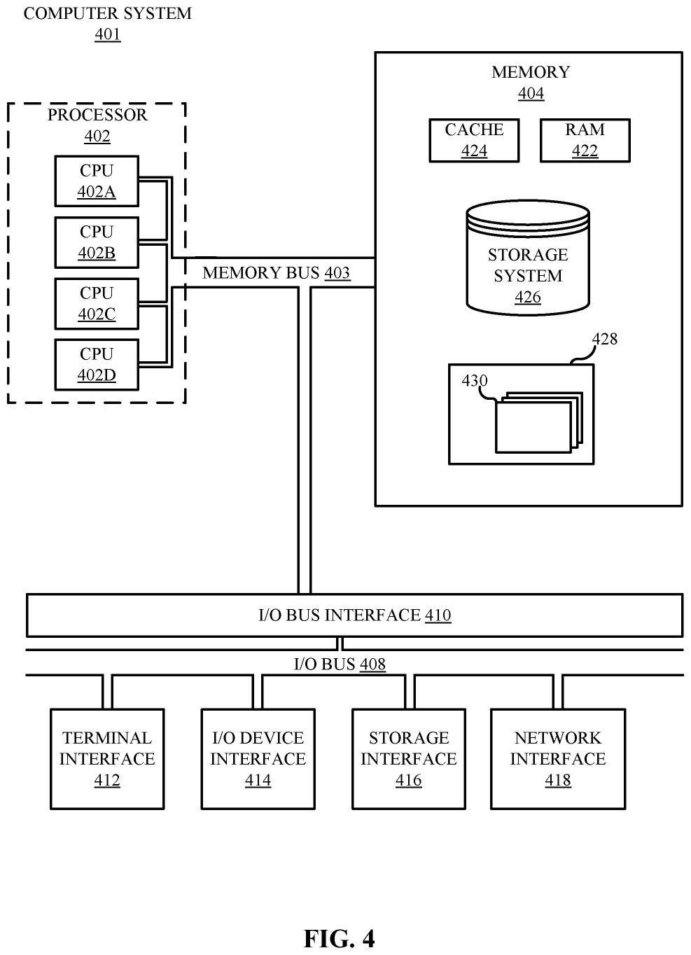

Referring now to FIG. 4, shown is a high-level block diagram of an example computer system 401 that may be used in implementing one or more of the methods, tools, and modules, and any related functions, described herein (e.g., using one or more processor circuits or computer processors of the computer), in accordance with embodiments of the present disclosure. In some embodiments, the major components of the computer system 401 may comprise one or more CPUs 402, a memory subsystem 404, a terminal interface 412, a storage interface 416, an I/O (Input/Output) device interface 414, and a network interface 418, all of which may be communicatively coupled, directly or indirectly, for inter-component communication via a memory bus 403, an I/O bus 408, and an I/O bus interface unit 410.

The computer system 401 may contain one or more general-purpose programmable central processing units (CPUs) 402A, 402B, 402C, and 402D, herein generically referred to as the CPU 402. In some embodiments, the computer system 401 may contain multiple processors typical of a relatively large system; however, in other embodiments the computer system 401 may alternatively be a single CPU system. Each CPU 402 may execute instructions stored in the memory subsystem 404 and may include one or more levels of on-board cache.

System memory 404 may include computer system readable media in the form of volatile memory, such as random access memory (RAM) 422 or cache memory 424. Computer system 401 may further include other removable/non-removable, volatile/non-volatile computer system storage media. By way of example only, storage system 426 can be provided for reading from and writing to a non-removable, non-volatile magnetic media, such as a “hard drive.” Although not shown, a magnetic disk drive for reading from and writing to a removable, non-volatile magnetic disk (e.g., a “floppy disk”), or an optical disk drive for reading from or writing to a removable, non-volatile optical disc such as a CD-ROM, DVD-ROM or other optical media can be provided. In addition, memory 404 can include flash memory, e.g., a flash memory stick drive or a flash drive. Memory devices can be connected to memory bus 403 by one or more data media interfaces. The memory 404 may include at least one program product having a set (e.g., at least one) of program modules that are configured to carry out the functions of various embodiments.

One or more programs/utilities 428, each having at least one set of program modules 430 may be stored in memory 404. The programs/utilities 428 may include a hypervisor (also referred to as a virtual machine monitor), one or more operating systems, one or more application programs, other program modules, and program data. Each of the operating systems, one or more application programs, other program modules, and program data or some combination thereof, may include an implementation of a networking environment. Program modules 430 generally perform the functions or methodologies of various embodiments.

Although the memory bus 403 is shown in FIG. 4 as a single bus structure providing a direct communication path among the CPUs 402, the memory subsystem 404, and the I/O bus interface 410, the memory bus 403 may, in some embodiments, include multiple different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface 410 and the I/O bus 408 are shown as single respective units, the computer system 401 may, in some embodiments, contain multiple I/O bus interface units 410, multiple I/O buses 408, or both. Further, while multiple I/O interface units are shown, which separate the I/O bus 408 from various communications paths running to the various I/O devices, in other embodiments some or all of the I/O devices may be connected directly to one or more system I/O buses.

In some embodiments, the computer system 401 may be a multi-user mainframe computer system, a single-user system, or a server computer or similar device that has little or no direct user interface, but receives requests from other computer systems (clients). Further, in some embodiments, the computer system 401 may be implemented as a desktop computer, portable computer, laptop or notebook computer, tablet computer, pocket computer, telephone, smart phone, network switches or routers, or any other appropriate type of electronic device.

It is noted that FIG. 4 is intended to depict the representative major components of an exemplary computer system 401. In some embodiments, however, individual components may have greater or lesser complexity than as represented in FIG. 4, components other than or in addition to those shown in FIG. 4 may be present, and the number, type, and configuration of such components may vary.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

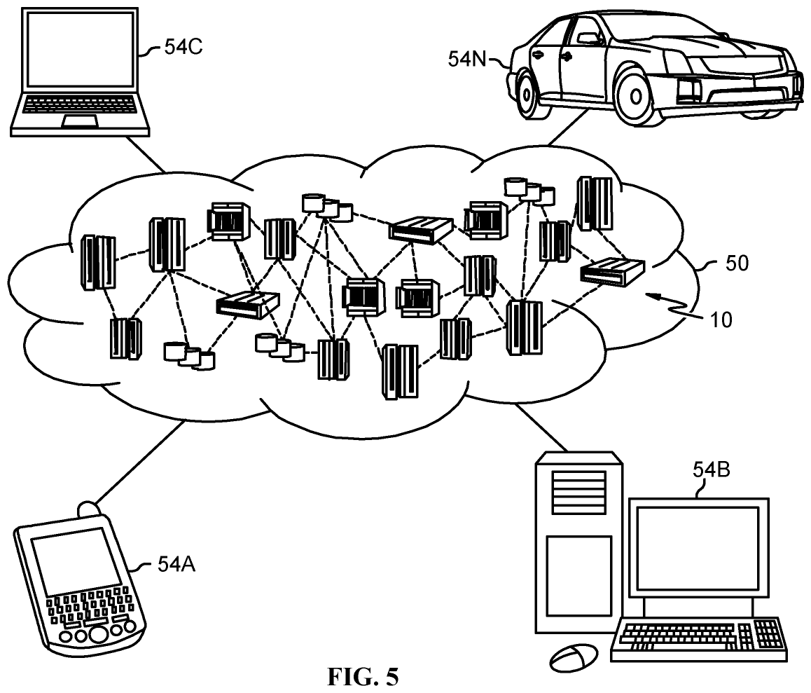

Referring now to FIG. 5, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 5 are intended to be illustrative only and that computing nodes 10 and cloud computing environment 50 can communicate with any type of computerized device over any type of network and/or network addressable connection (e.g., using a web browser).

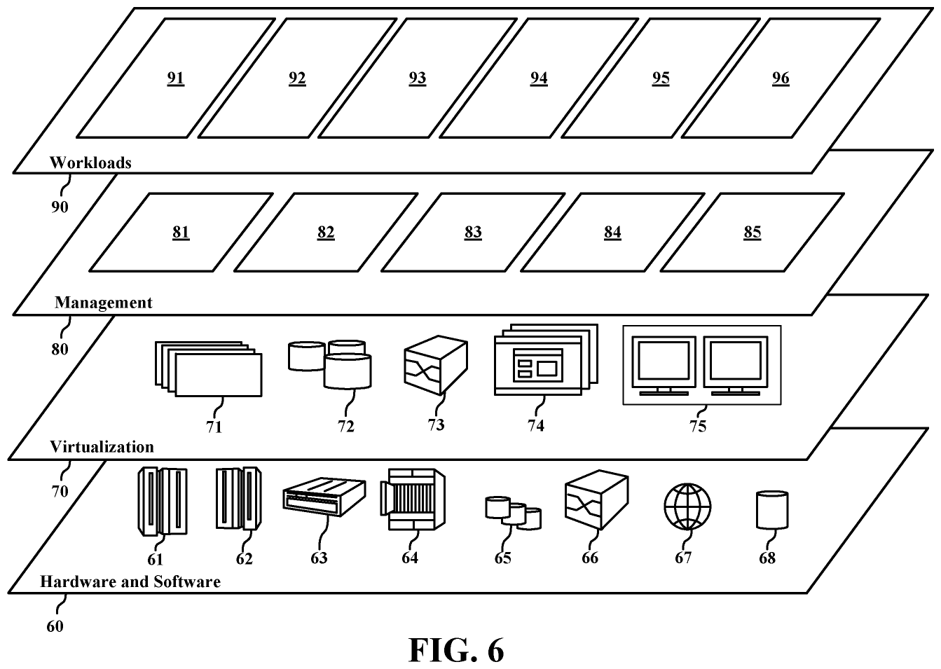

Referring now to FIG. 6, a set of functional abstraction layers provided by cloud computing environment 50 (FIG. 5) is shown. It should be understood in advance that the components, layers, and functions shown in FIG. 6 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and mobile desktops 96.

In addition to embodiments described above, other embodiments having fewer operational steps, more operational steps, or different operational steps are contemplated. Also, some embodiments may perform some or all of the above operational steps in a different order. Furthermore, multiple operations may occur at the same time or as an internal part of a larger process. The modules are listed and described illustratively according to an embodiment and are not meant to indicate necessity of a particular module or exclusivity of other potential modules (or functions/purposes as applied to a specific module).

In the foregoing, reference is made to various embodiments. It should be understood, however, that this disclosure is not limited to the specifically described embodiments. Instead, any combination of the described features and elements, whether related to different embodiments or not, is contemplated to implement and practice this disclosure. Many modifications and variations may be apparent to those of ordinary skill in the art without departing from the scope and spirit of the described embodiments. Furthermore, although embodiments of this disclosure may achieve advantages over other possible solutions or over the prior art, whether or not a particular advantage is achieved by a given embodiment is not limiting of this disclosure. Thus, the described aspects, features, embodiments, and advantages are merely illustrative and are not considered elements or limitations of the appended claims except where explicitly recited in a claim(s).

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the various embodiments. As used herein, the singular forms “a,” “an,” and “the” are intended to include the plural forms as well, unless the context clearly indicates otherwise. It will be further understood that the terms “includes” and/or “including,” when used in this specification, specify the presence of the stated features, integers, steps, operations, elements, and/or components, but do not preclude the presence or addition of one or more other features, integers, steps, operations, elements, components, and/or groups thereof. In the previous detailed description of example embodiments of the various embodiments, reference was made to the accompanying drawings (where like numbers represent like elements), which form a part hereof, and in which is shown by way of illustration specific example embodiments in which the various embodiments may be practiced. These embodiments were described in sufficient detail to enable those skilled in the art to practice the embodiments, but other embodiments may be used and logical, mechanical, electrical, and other changes may be made without departing from the scope of the various embodiments. In the previous description, numerous specific details were set forth to provide a thorough understanding the various embodiments. But, the various embodiments may be practiced without these specific details. In other instances, well-known circuits, structures, and techniques have not been shown in detail in order not to obscure embodiments.

As used herein, “a number of” when used with reference to items, means one or more items. For example, “a number of different types of networks” is one or more different types of networks.

When different reference numbers comprise a common number followed by differing letters (e.g., 100a, 100b, 100c) or punctuation followed by differing numbers (e.g., 100-1, 100-2, or 100.1, 100.2), use of the reference character only without the letter or following numbers (e.g., 100) may refer to the group of elements as a whole, any subset of the group, or an example specimen of the group.

Further, the phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, or item C” may include item A, item A and item B, or item B. This example also may include item A, item B, and item C or item B and item C. Of course, any combinations of these items can be present. In some illustrative examples, “at least one of” can be, for example, without limitation, two of item A; one of item B; and ten of item C; four of item B and seven of item C; or other suitable combinations.

Different instances of the word “embodiment” as used within this specification do not necessarily refer to the same embodiment, but they may. Any data and data structures illustrated or described herein are examples only, and in other embodiments, different amounts of data, types of data, fields, numbers and types of fields, field names, numbers and types of rows, records, entries, or organizations of data may be used. In addition, any data may be combined with logic, so that a separate data structure may not be necessary. The previous detailed description is, therefore, not to be taken in a limiting sense.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Although the present invention has been described in terms of specific embodiments, it is anticipated that alterations and modification thereof will become apparent to the skilled in the art. Therefore, it is intended that the following claims be interpreted as covering all such alterations and modifications as fall within the true spirit and scope of the invention.

What is claimed is:

1. A method comprising:
in response to receiving a first request from a first virtualized communication endpoint (VCE), allocating and assigning a first communication portal to the first VCE, generating an encryption key associated with the first communication portal, and returning the encryption key and an identification of the first communication portal to the first VCE;
in response to receiving a second request from a second VCE to establish a communicative connection with the first communication portal, the second request being accompanied by an encrypted certificate, comparing, using the encryption key, the information included in the certificate with certificate input information; and
in response to determining that the information included in the certificate matches the certificate input information, establishing the communicative connection between the first VCE and the second VCE.

2. The method of claim 1, wherein the certificate input information includes:
the identification of the second VCE;
an identification of a second communication portal that is assigned to the second VCE; and
the identification of the first communication portal.

3. The method of claim 2, wherein the communicative connection is established between the first communication portal and the second communication portal.

4. The method of claim 1, wherein comparing information included in the certificate includes decrypting the information included in the certificate using the encryption key.

5. The method of claim 1, wherein the encryption key is a symmetric encryption key.

6. The method of claim 1, wherein:
the first VCE is associated with a first virtual machine;
the second VCE is associated with a second virtual machine; and
the method is performed by a hypervisor that hosts the first and second virtual machines.

7. The method of claim 6, wherein the first virtual machine is distinct from the second virtual machine.

8. The method of claim 1, further comprising sending a notification to the second VCE indicating that the communicative connection has been established.

9. A computer program product comprising a computer readable storage medium having program instructions embodied therewith, the program instructions executable by processor to cause the processor to perform a method comprising:
in response to receiving a first request from a first virtualized communication endpoint (VCE), allocating and assigning a first communication portal to the first VCE, generating an encryption key associated with the first communication portal, and returning the encryption key and an identification of the first communication portal to the first VCE;
in response to receiving a second request from a second VCE to establish a communicative connection with the first communication portal, the second request being accompanied by an encrypted certificate, comparing, using the encryption key, the information included in the certificate with certificate input information; and
in response to determining that the information included in the certificate matches the certificate input information, establishing the communicative connection between the first VCE and the second VCE.

10. The computer program product of claim 9, wherein the certificate input information includes:
the identification of the second VCE;
an identification of a second communication portal that is assigned to the second VCE; and
the identification of the first communication portal.

11. The computer program product of claim 10, wherein the communicative connection is established between the first communication portal and the second communication portal.

12. The computer program product of claim 9, wherein comparing information included in the certificate includes decrypting the information included in the certificate using the encryption key.

13. The computer program product of claim 9, wherein the encryption key is a symmetric encryption key.

14. The computer program product of claim 9, wherein:
the first VCE is associated with a first virtual machine;
the second VCE is associated with a second virtual machine, the second virtual machine being distinct from the first virtual machine; and
the method is performed by a hypervisor that hosts the first and second virtual machines.

15. A computer system, comprising:
a memory; and
a processor communicatively coupled to the memory, wherein the processor is configured to perform a method comprising:
in response to receiving a first request from a first virtualized communication endpoint (VCE), allocating and assigning a first communication portal to the first VCE, generating an encryption key associated with the first communication portal, and returning the encryption key and an identification of the first communication portal to the first VCE;
in response to receiving a second request from a second VCE to establish a communicative connection with the first communication portal, the second request being accompanied by an encrypted certificate, comparing, using the encryption key, the information included in the certificate with certificate input information; and
in response to determining that the information included in the certificate matches the certificate input information, establishing the communicative connection between the first VCE and the second VCE.

16. The computer system of claim 15, wherein the certificate input information includes:
the identification of the second VCE;
an identification of a second communication portal that is assigned to the second VCE; and
the identification of the first communication portal

17. The computer system of claim 16, wherein the communicative connection is established between the first communication portal and the second communication portal.

18. The computer system of claim 15, wherein comparing information included in the certificate includes decrypting the information included in the certificate using the encryption key.

19. The computer system of claim 15, wherein the encryption key is a symmetric encryption key.

20. The computer system of claim 15, wherein:
the first VCE is associated with a first virtual machine;
the second VCE is associated with a second virtual machine distinct from the first virtual machine; and
the method is performed by a hypervisor that hosts the first and second virtual machines.
